(19) United States
(12) Patent Application Publication
(10) Pub. No.: US 2014/0325148 A1
(43) Pub. Date: Oct. 30, 2014

(54) DATA STORAGE DEVICES WHICH SUPPLY HOST WITH DATA PROCESSING LATENCY INFORMATION, AND RELATED DATA PROCESSING METHODS

(71) Applicants: SANG HOON CHOI, SEOUL (KR); SANG PHIL KIM, GWANGMYEONG-SI (KR); MOON SANG KWON, SEOUL (KR); YU SUNG KIM, GIMPO-SI (KR); HYUNG JIN KIM, HWASEONG-SI (KR); JEANG SU HWANG, SUWON-SI (KR)

(72) Inventors: SANG HOON CHOI, SEOUL (KR); SANG PHIL KIM, GWANGMYEONG-SI (KR); MOON SANG KWON, SEOUL (KR); YU SUNG KIM, GIMPO-SI (KR); HYUNG JIN KIM, HWASEONG-SI (KR); JEANG SU HWANG, SUWON-SI (KR)

(21) Appl. No.: 14/264,119

(22) Filed: Apr. 29, 2014

Related U.S. Application Data
(60) Provisional application No. 61/816,822, filed on Apr. 29, 2013.

(30) Foreign Application Priority Data
Oct. 1, 2013 (KR) 10-2013-0117519

(51) Int. Cl. G06F 3/06

(52) U.S. Cl. CPC G06F 3/0611; G06F 3/0689; G06F 3/0665
USPC 711/114

(57) ABSTRACT

A method is for operating a data storage device including a plurality of memory chips. The method includes generating state information regarding the plurality of memory chips, storing the generated state information in a memory, receiving an access command from a host, analyzing the state information in response to the access command, and transmitting a response to the host indicative of whether the access command is performed based on the analyzed state information.

### CROSS-REFERENCE TO RELATED APPLICATIONS

A claim of priority is made to U.S. provisional patent application No. 61/816,822 filed on Apr. 29, 2013, and to Korean Patent Application No. 10-2013-0117519 filed on Oct. 1, 2013, the entire contents of each of which are hereby incorporated by reference.

### BACKGROUND

Embodiments of the present inventive concept relate to data storage devices. More particularly, embodiments of the present inventive concept relate to data storage devices which are configured to supply a host device with data processing latency information, and to related data processing methods.

A data processing system generally includes a data storage device which stores data, and a host which controls data read and data write operations of the data storage device. That is, the host is configured to transmit a read command or a write command to the storage device, and the storage device configured to execute the thus transmitted read command or write command. However, the storage device may be in the midst of executing a given operation when the read command or write command is transmitted from the host. In this case, execution of the read command or write command may be delayed until the given operation is completed.

### SUMMARY

According to an example embodiment, a method of operating a data storage device including a plurality of memory chips is provided. The method includes generating state information regarding the plurality of memory chips, and storing the generated state information in a memory, receiving an access command from a host, and analyzing the state information in response to the access command, and transmitting a response to the host indicative of whether the access command is performed based on the analyzed state information.

The state information may include information regarding a background operation of each of the plurality of chips, and the background operation may include at least one of a garbage collection operation, a wear-level operation, and a bad-block management operation.

The state information may include information regarding at least one of a program operation, a read operation, and an erase operation to be performed in each of the plurality of memory chips.

The state information may include information regarding a state of a bus connected to the plurality of memory chips.

The state information may include information regarding an operation being currently performed in the plurality of memory chips.

The access command may include one of a read command and a write command.

The response may be indicative of whether the access command is being currently performed.

The response may be indicative of a latency at which the access command will be performed.

The response may be a timeout response or an abort response.

According to another example embodiment, a method of operating a data storage device including a plurality of memory chips is provided. The method includes generating state information regarding the plurality of memory chips, storing the generated state information in a memory, receiving an access command from a host, analyzing the state information in response to the access command to determine whether an addressed one of the plurality of memory chips is currently available, and transmitting a response to the host based on the analyzed state information. When the addressed one of the plurality of memory chips is determined to be currently available, the response is indicative of the access command being performed. When addressed one of the plurality of memory chips is determined to be currently not available, the response is indicative of at least one of the access command not being performed and a latency at which the access command will be performed.

According to still another example embodiment, a method is provided of operating a data processing system which includes a first data storage device having first memory chips, a second data storage device having second memory chips, and a host. The method includes transmitting, by the host, a first access command to the first data storage device. The method further includes analyzing, by the first data storage device, state information regarding the first memory chips in response to the first access command, and transmitting a response indicative of whether to execute the first access command based on a result of the analyzing. The method still further includes deferring, by the host, an access operation to the first data storage device based on the response and transmitting a second access command to the second data storage device. The method further includes performing, by the second data storage device, an operation corresponding to the second access command to the second memory chips.

The first data storage device may generate the state information before receiving the first access command, and the state information may include at least one of information regarding a background operation, an operation count to be performed in each of the plurality of memory chips, a state of a bus connected to the plurality of memory chips, and an operation being currently performed in the plurality of memory chips.

The response may be indicative of whether the access command is being currently performed or a latency at which the access command will be performed.

The first data storage device and the second data storage device may be included in a Redundant Array of Independent Disks or Redundant Array of Inexpensive Disks (RAID).

The first data storage device and the second data storage device may be solid state drives (SSDs), and the first memory chips and the second memory chips may be flash memory chips.

The first data storage device and the second data storage device may be included in a database, the host may be a database server, and the data processing system is a database management system (DBMS).

The method may further include transmitting to the host, by the second data storage device, read data read according to the operation corresponding to the second access command.

The method may further include receiving, by a web server connected to the host, a search criteria from a user browser, transmitting, by the web server, a command corresponding to the search criteria to the host, and generating, by the host, the first access command corresponding to the command. The method may still further include transmitting, by the second data storage device, read data read according to the operation corresponding to the second access command to the host, transmitting, by the host, the read data to the web server, and transmitting, by the web server, the read data transmitting from the web server to the user browser.

According to yet another example embodiment, a data storage device is provided which includes a plurality of memory chips and a storage controller. The storage controller generates state information regarding the plurality of memory chips, stores the generated state information in a memory, analyzes the state information stored in the memory in response to an access command received from a host, and transmits a response indicative of whether to perform the access command to the host according to a result of the analyzing.

The data storage device may further include a central processing unit (CPU) integrated in the storage controller, and a memory controller which is integrated in the storage controller and controls an operation of the plurality of memory chips. Further, the state information may be generated by one of the CPU and the memory controller, and the state information may include at least one of information regarding a background operation, an operation count to be performed in each of the plurality of memory chips, a state of a bus connected to the plurality of memory chips, and an operation being currently performed in the plurality of memory chips.

The memory may be embedded in the storage controller.

The memory may be a main memory device embodied outside the storage controller.

The response may be indicative of a latency of an operation corresponding to the access command.

### BRIEF DESCRIPTION OF THE DRAWINGS

Various aspects and features of the present inventive concept will become readily apparent from the detailed description that follows, with reference to the accompanying drawings, in which:

FIG. 1 is a schematic block diagram of a data processing system according to an exemplary embodiment of the present inventive concepts;

FIG. 2 is a schematic block diagram of a data processing system according to another exemplary embodiment of the present inventive concepts;

FIG. 3 depicts a table in which state information is stored according to an exemplary embodiment of the present inventive concepts;

FIG. 4 depicts a table in which state information is stored according to another exemplary embodiment of the present inventive concepts;

FIG. 5 depicts a table in which state information is stored according to still another exemplary embodiment of the present inventive concepts;

FIG. 6 is a schematic block diagram of a data processing system according to still another exemplary embodiment of the present inventive concepts;

FIG. 7 is a flowchart for describing an exemplary embodiment of an operation of the data processing systems illustrated in FIGS. 1, 2 and 6;

FIG. 8 is a flowchart for describing another exemplary embodiment of an operation of the data processing systems illustrated in FIGS. 1, 2 and 6;

FIG. 9 is a schematic block diagram of a data processing system according to still another exemplary embodiment of the present inventive concepts;

FIG. 10 is a flowchart for describing an exemplary embodiment of an operation of the data processing system illustrated in FIG. 9;

FIG. 11 is a schematic block diagram of a data processing system according to still another exemplary embodiment of the present inventive concepts; and

FIG. 12 is a flowchart for describing an exemplary embodiment of an operation of the data processing system illustrated in FIG. 11.

### DETAILED DESCRIPTION OF THE EMBODIMENTS

The present inventive concepts now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

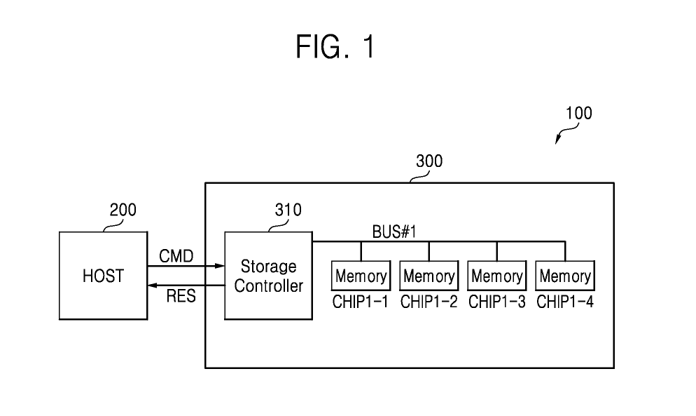

FIG. 1 is a schematic block diagram of a data processing system according to an exemplary embodiment of the present inventive concepts. Referring to FIG. 1, a data processing system 100 includes a host 200 and a data storage device 300. As examples, the data processing system 100 may be a personal computer (PC), a laptop computer, or a database management system (DBMS).

The data storage device 300 may store data processed by or to be processed by the host 200, and the host 200 may output an access command to the data storage device 300 in order to control an access operation of the data storage device 300. As examples, the access command may be a read command or a write command CMD, and the access operation may be read operation or a write operation, of the data storage device 300, to the data storage device 300.

The host 200 may be connected to the data storage device 300 through any of a large variety of different interface protocols, a few examples of which include Serial Advance Technology Attachment (SATA), Serial-Attached Small Computer System Interface (SAS), and Peripheral Component Interconnect Express (PCIe).

The data storage device 300 may include one or more of different types of storage media, and may, as examples, be embodied in a hard disc drive (HDD) or a solid state drive (SSD). Other example embodiments of the data storage device 300 include a Universal Serial Bus (USB) flash drive, a Universal Flash Storage (UFS), a Multi-Media Card (MMC), or an embedded MMC (eMMC).

The data storage device 300 of this example includes a plurality of memory chips CHIP1-1 to CHIP1-4 and a storage controller 310. For example, the plurality of memory chips CHIP1-1 to CHIP1-4 may be embodied as flash memory chips including memory cells each storing one or more bits of data.

The storage controller 310 may, as examples, be embodied in an integrated circuit (IC) or a system on chip (SoC).

As will be explained herein in detail, according to some example embodiments, the storage controller 310 is configured to generate state information with respect the plurality of memory chips CHIP1-1 to CHIP1-4, to store the generated state information in a memory, to analyze the state information stored in the memory in response to an access command (CMD) received from the host 200, and, based on an analyzed result, to transmit a response (RES) to the host 200 indicative of whether the access command (CMD) is performed (i.e., executed).

The state information may, for example, be information relating to background operations of the memory chips CHIP1-1 to CHIP1-4. As example, the state information may be information indicative of an operation count to be performed in each of the plurality of memory chips CHIP1-1 to CHIP1-4, information relating a state of a bus (BUS#1) to which the plurality of memory chips CHIP1-1 to CHIP1-4 are connected, and/or information relating to an operation being currently performed in the plurality of memory chips CHIP1-1 to CHIP1-4.

As mentioned above, the access command CMD may be a command which requests execution of a read operation or a write operation from or to the data storage device 300. Also, according to an exemplary embodiment, the access command CMD may be a vendor specific command. Here, the access command CMD may be a new command (or newly defined-command) which is different from a read command or a write operation.

According to another exemplary embodiment, the access command CMD may be a command which includes a request command and a read command, or a request command and a write command. Here, the request command may be a command which requests an indication of the availability of the data storage device 300 to perform a read operation or a write operation.

According to an exemplary embodiment, a response RES may indicate whether it is possible to currently perform an access command CMD, that is, a read command or a write command. According to another exemplary embodiment, the response RES may represent a time at which it will be possibly perform the read command or the write command.

According to still another exemplary embodiment, the response RES may indicate an operational latency (or delay) of execution of the access command CMD. According to still another exemplary embodiment, the response RES may be a timeout response about the access command CMD or an abort response about the access command CMD. The timeout response or the abort response is not a response about an actual timeout or a response about an actual abort, but is a fast response generated when latency (or delay) more than fixed time for an operation corresponding to the access command CMD is estimated.

According to an exemplary embodiment, when the access command CMD is a vendor specific command which requests only an indication of whether an access operation, e.g., a read operation or a write operation, can be performed without abnormal delay, and when the response RES thereto indicates that the access operation can be performed, the host 200 may transmit a read command for a read operation or a write command for a write operation to the data storage device 300 based on the response RES.

For example, when a background operation is currently being performed or is to be performed in the data storage device 300, or a specific operation is currently being performed or is to be performed in each of the plurality of memory chips CHIP1-1 to CHIP1-4, the abnormal delay may occur. The specific operation may be a program operation, a read operation, or an erase operation.

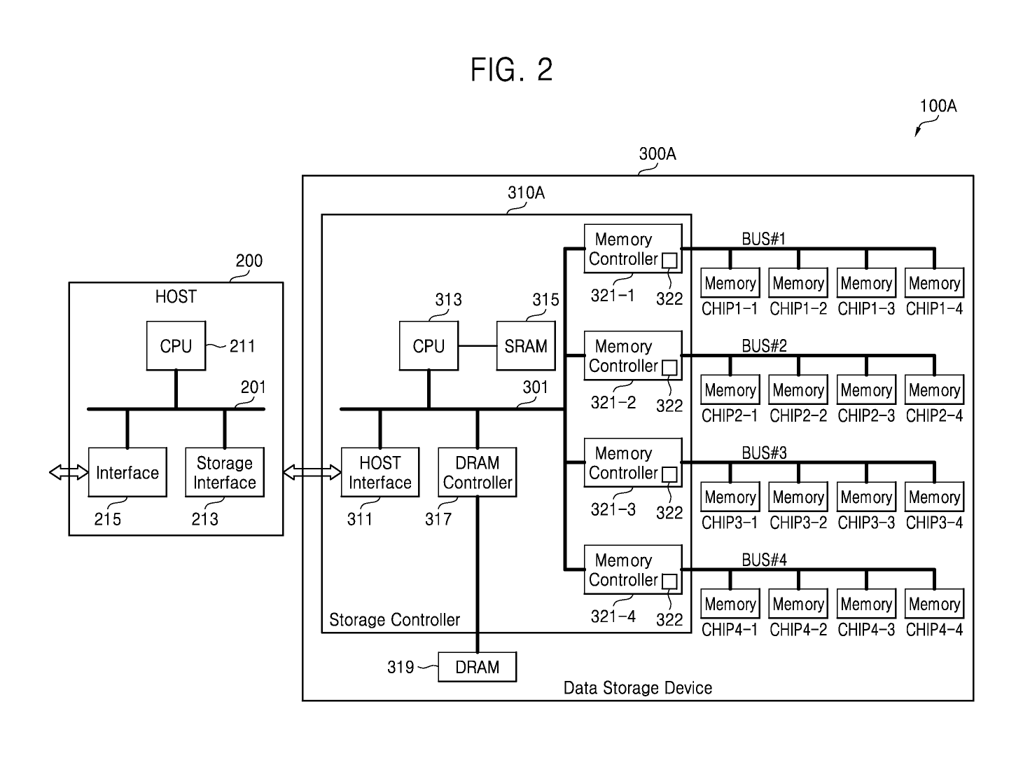

FIG. 2 is a schematic block diagram of a data processing system according to another exemplary embodiment of the present inventive concepts. A data processing system 100A according to an exemplary embodiment of the data processing system 100 of FIG. 1 includes a host 200 and a data storage device 300A.

The host 200 includes a central processing unit (CPU) 211 which may control an operation of the host 200, and a storage interface 213. The CPU 211 may generate an access command CMD, and transmit the access command CMD to a host interface 311 through the storage interface 213. The CPU 211 may analyze a response RES received through the storage interface 213 and generate other commands based on a result of analyzing the response RES.

The host 200 may further include an interface 215 which may communicate with other external devices. The CPU 211 may control an operation of each component 213 and 215 through connection mechanisms, e.g., a bus 201. Each interface 213 and 311 may support SATA, SAS or PCIe.

The data storage device 300A may include a storage controller 310A, a main memory device 319, and a plurality of memory chips CHIP1-1 to CHIP1-4, CHIP2-1 to CHIP2-4, CHIP3-1 to CHIP3-4, and CHIP4-1 to CHIP4-4 connected to each bus BUS#1 to BUS#4.

The storage controller 310A includes a host interface 311, a CPU 313, a volatile memory device 315, e.g., a static random access memory (SRAM), a main memory controller 317, and a plurality of memory controllers 321-1 to 321-4.

The host 200 and the storage controller 310A may transmit or receive data and/or commands to/from each other through the host interface 311. The CPU 313 may control an operation of each component 311, 315, 317, and 321-1 to 321-4 through connection mechanisms, e.g., a bus 301. The SRAM 315 may store data necessary in the CPU 313 or data processed in the CPU 313.

In FIG. 2, the SRAM 315 is illustrated outside the CPU 313, but the SRAM 315 may be embedded in the CPU 313 according to an exemplary embodiment.

The main memory controller 317 may transmit or receive data and/or commands to/from a main memory device 319. For example, when the main memory device 319 is embodied in a DRAM, the main memory controller 317 may be embodied in a DRAM controller. Each memory controller 321-1 to 321-4 may control an operation of the plurality of memory chips CHIP1-1 to CHIP1-4, CHIP2-1 to CHIP2-4, CHIP3-1 to CHIP3-4, and CHIP4-1 to CHIP4-4 connected to each bus BUS#1 to BUS#4.

For convenience of description in FIG. 2, four memory controllers 321-1 to 321-4 connected to four buses BUS#1 to BUS#4 are illustrated; however, the inventive concepts are not limited by any particular number of memory controllers and/or buses.

According to an exemplary embodiment, state information on the plurality of memory chips CHIP1-1 to CHIP1-4, CHIP2-1 to CHIP2-4, CHIP3-1 to CHIP3-4, and CHIP4-1 to CHIP4-4 may be stored in the SRAM 315, the main memory device 319, or a memory or register 322 embedded in each memory controller 321-1 to 321-4.

According to another exemplary embodiment, the state information may be stored in at least one of the plurality of memory chips CHIP1-1 to CHIP1-4, CHIP2-1 to CHIP2-4, CHIP3-1 to CHIP3-4, and CHIP4-1. According to an exemplary embodiment, the state information may be generated by the CPU 313 or by each memory controller 321-1 to 321-4. The state information may be stored in tabular form in a corresponding memory 315, 319 or 322.

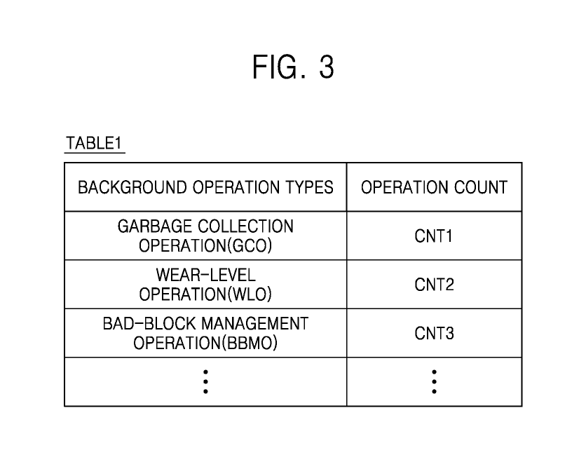

The state information may be stored in tabular form according to exemplary embodiments of the present inventive concepts. That is, referring to the example of FIG. 1, the storage controller 310 may generate store state information (e.g., background operation information) regarding the memory chips CHIP1-1 through CHIP1-4 as a data table. Likewise, referring to FIG. 2, the CPU 313 and/or each memory controller 321-1 to 321-4 may generate state information (e.g., background operation information) regarding the memory chips CHIP1-1 through CHIP4-4, and store the generated state information as a data table in a memory 315, 319, and/or 322. Examples of such data tables are described next with reference to FIGS. 3, 4 and 5, each depicting exemplary embodiments of the inventive concepts.

The data table (TABLE1) represented by the exemplary embodiment of FIG. 3 illustrates an example in which the state information is background operation information. In particular, in this example, the data table stores an operation count for each of different types of background operation, such as a garbage collection operation GCO, a wear-level operation WLO, and a bad-block management operation BBMO.

Each count value CNT1, CNT2, and CNT3 for each operation GCO, WLO, and BBMO to be performed is stored in an operation count OPERATION COUNT column of the data table TABLE1. Herein, the count value represents the number of times of each operation GCO, WLO, and BBMO is being performed. In this particular example, a count value of 0 (zero) means that no corresponding operation is being performed. Thus, when each count value CNT1, CNT2, and CNT3 for respective operation GCO, WLO, and BBMO is zero, a determination may be made that a background operation is not being performed the data storage device.

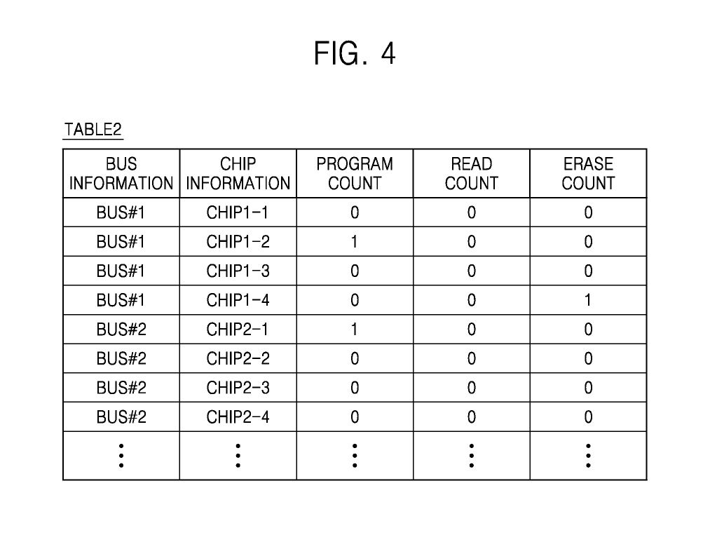

The data table (TABLE2) of the exemplary embodiment of FIG. 4 represents an example in which the state information is indicative of one or more operations (e.g., program, read and erase operations) associated with each chip of each bus of a storage device such as that shown in FIG. 2. As suggested above, the data table (TABLE2) may, for example, be stored a memory 315, 319, and/or 322 of FIG. 2.

As exemplarily illustrated in TABLE2 of FIG. 4, the state information includes an operation count indicative of a number of operations to be performed in each of the memory chips CHIP1-1 to CHIP1-4, memory chips CHIP2-1 to CHIP2-4, memory chips CHIP3-1 to CHIP3-4, and memory chips CHIP4-1 to CHIP4-4. In this example, the operation count includes at least one of the number of program operations PROGRAM COUNT, the number of read operations READ COUNT, and the number of erase operations ERASE COUNT to be performed in each of the memory chips CHIP1-1 to CHIP1-4, memory chips CHIP2-1 to CHIP2-4, memory chips CHIP3-1 to CHIP3-4, and memory chips CHIP4-1 to CHIP4-4.

As described above, state information stored in TABLE2 may represent a current status and a pending operation count for each of the memory chips CHIP1-1 to CHIP1-4, memory chips CHIP2-1 to CHIP2-4, memory chips CHIP3-1 to CHIP3-4, and memory chips CHIP4-1 to CHIP4-4.

In the particular example of TABLE2 of FIG. 4, the number of program operations to be performed on a memory chip CHIP1-2 connected to a bus BUS#1 is one, the number of erase operations to be performed on a memory chip CHIP1-4 connected to the bus BUS#1 is one, and the number of program operations to be performed on a memory chip CHIP2-1 connected to the bus BUS#2 is one.

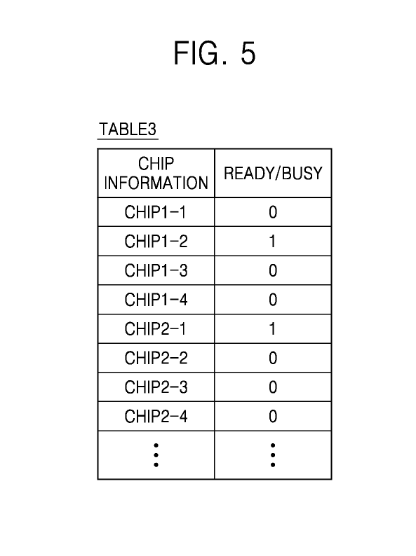

The data table (TABLE3) of the exemplary embodiment of FIG. 5 represents an example in which the state information is indicative of ready/busy state (READY/BUSY) of each of the memory chips CHIP1-1 to CHIP1-4, memory chips CHIP2-1 to CHIP2-4, memory chips CHIP3-1 to CHIP3-4, and memory chips CHIP4-1 to CHIP4-4. As suggested above, the TABLE2 may, for example, be stored a memory 315, 319, and/or 322 of FIG. 2. In FIG. 5, “0” represents a ready state (READY) and “1” represents a busy state (BUSY).

State information stored in a table 3 TABLE3 represents a state of each memory chip CHIP1-1 to CHIP1-4, CHIP2-1 to CHIP2-4, CHIP3-1 to CHIP3-4, and CHIP4-1, which is determined from a viewpoint of each memory controller 321-1 to 321-4.

As illustrated in the table 3 TABLE3, a state of a memory chip CHIP1-2 connected to the bus BUS#1 is busy BUSY, and a state of a memory chip CHIP2-1 connected to the bus BUS#2 is busy BUSY. The CPU 313 and/or each memory controller 321-1 to 321-4 may determine a state of each bus BUS#1 to BUS#4, e.g., an availability, based on the table 3 TABLE3.

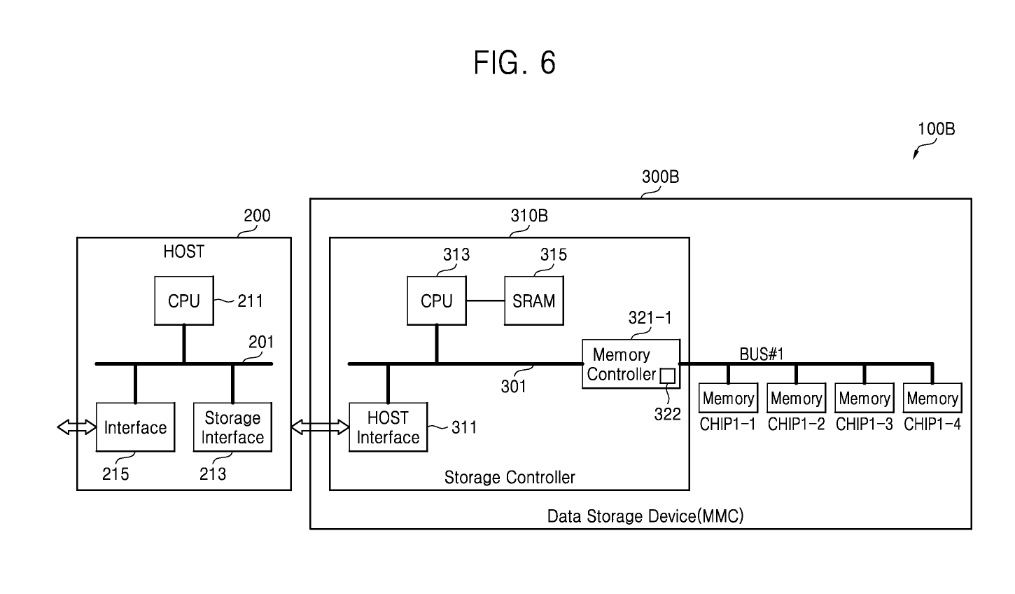

FIG. 6 is a schematic block diagram of a data processing system according to still another exemplary embodiment of the present inventive concepts. A data processing system 100B according to another exemplary embodiment of the data processing system 100 of FIG. 1 includes a host 200 and a data storage device 300B.

The data storage device 300B of FIG. 6, unlike the data storage device 300A of FIG. 2, does not include a main memory device and a main memory device controller which controls the main memory device, but includes one memory controller 321-1. For example, the data storage device 300B may be embodied in MMC or eMMC.

Each interface 213 and 311 may support an MMC interface or an eMMC interface. The memory controller 321-1 may control an operation of a plurality of memory chips CHIP1-1 to CHIP1-4 connected to the bus BUS#1.

According to an exemplary embodiment, state information on the plurality of memory chips CHIP1-1 to CHIP1-4 may be stored in the SRAM 315 or a memory or a register 322 embedded in the memory controller 321-1. According to another exemplary embodiment, the state information may be stored in at least one of the plurality of memory chips CHIP1-1 to CHIP1-4. The state information may be generated by the CPU 313, or by the memory controller 321-1.

In each table TABLE1 to TABLE3 described referring to FIGS. 3 to 5, only state information on the plurality of memory chips CHIP1-1 to CHIP1-4 may be stored.

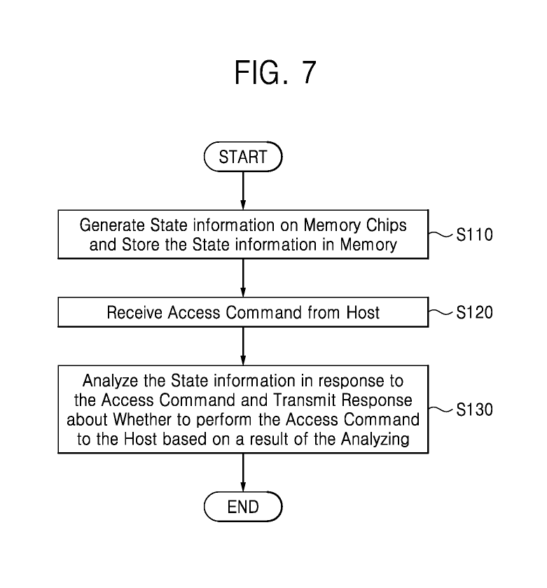

FIG. 7 is an exemplary embodiment of a flowchart for describing an operation of the data processing system illustrated in FIG. 1, 2, or 6. Referring to FIGS. 1 to 5, and 7, the CPU 313 of the data storage device 300A or each memory controller 321-1 to 321-4 may generate state information on each memory chip CHIP1-1 to CHIP1-4, CHIP2-1 to CHIP2-4, CHIP3-1 to CHIP3-4, and CHIP4-1, and store the generated state information in a corresponding memory 315, 319, or 322 or at least one of the memory chips CHIP1-1 to CHIP1-4, CHIP2-1 to CHIP2-4, CHIP3-1 to CHIP3-4, and CHIP4-1 (S110).

The CPU 313 of the data storage device 300A receives an access command CMD output from the host 200 (S120), analyzes the state information based on the access command CMD, and transmits a response RES about whether to perform the access command CMD to the host based on a result of the analyzing (S130).

Referring to FIGS. 1, 6, and 7, the CPU 313 of the data storage device 300 or 300B or the memory controller 321-1 may generate state information on each memory chip CHIP1-1 to CHIP1-4, and store the generated state information in a corresponding memory 315 or 322 or at least one of the memory chips CHIP1-1 to CHIP1-4 (S110).

The CPU 313 of the data storage device 300 or 300B receives an access command CMD output from the host 200 (S120), analyzes the state information based on the access command CMD, and transmits a response RES about whether to execute the access command CMD to the host (S130).

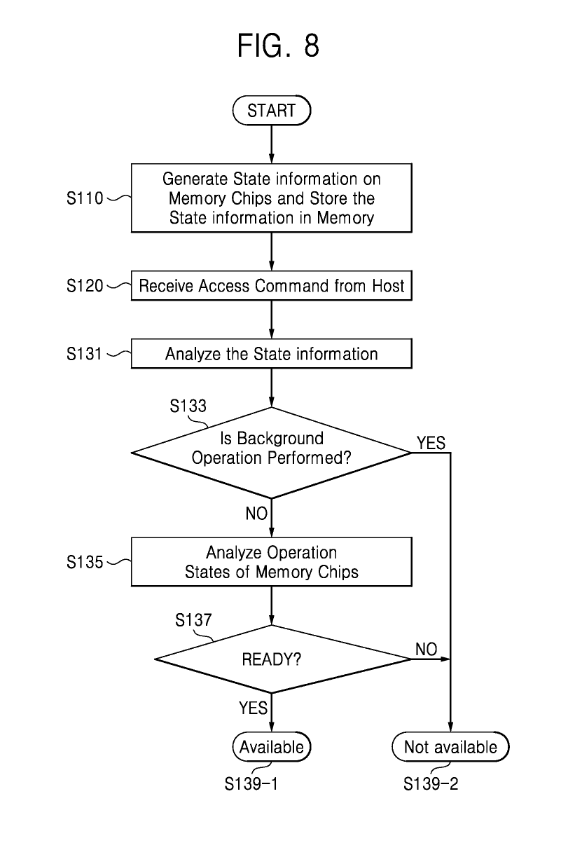

FIG. 8 is another exemplary embodiment of the flowchart for describing an operation of the data processing system illustrated in FIG. 1, 2, or 6. Referring to FIGS. 7 and 8, the CPU 313 analyzes (or interprets) the state information (S131).

When a background operation is currently performed (or operated) or to be perform (or operate) in the data storage device 300, 300A, or 300B (collectively 300) (S133), the CPU 313 transmits a response RES, which indicates that a read operation or a write operation corresponding the access command CMD may not be currently performed, to the host 200 (S139-2). Here, the CPU 133 may transmit the response RES to the host 200 referring to the table 1 TABLE1 (S139-2).

When the background operation is not currently performed or there is no background operation to be performed in the data storage device 300(S133), the CPU 313 analyzes an operation state of the memory chips CHIP1-1 to CHIP1-4, CHIP2-1 to CHIP2-4, CHIP3-1 to CHIP3-4, and CHIP4-1 (S135).

When an operation state of the memory chips CHIP1-1 to CHIP1-4, CHIP2-1 to CHIP2-4, CHIP3-1 to CHIP3-4, and CHIP4-1 is ready READY, the CPU 313 transmits a response RES, which indicates that a read operation or a write operation corresponding to an access command CMD may be currently performed, to the host 200 (S139-1). Here, the CPU 313 may transmit the response RES to the host 200 referring to the table 2 TABLE2 and/or the table 3 TABLE3 (S139-1).

When an operation state of the memory chips CHIP1-1 to CHIP1-4, CHIP2-1 to CHIP2-4, CHIP3-1 to CHIP3-4, and CHIP4-1 is not ready READY, the CPU 313 may transmit the response RES indicating a read operation or a write operation corresponding to an access command CMD may not be currently performed to the host 200 (S139-2). Here, the CPU 313 may transmit the response RES to the host 200 referring to the table 2 TABLE2 and/or the table 3 TABLE3 (S139-2).

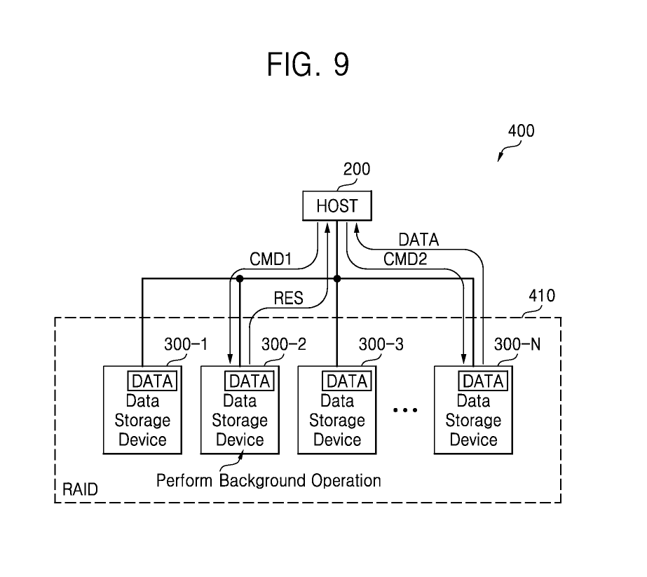

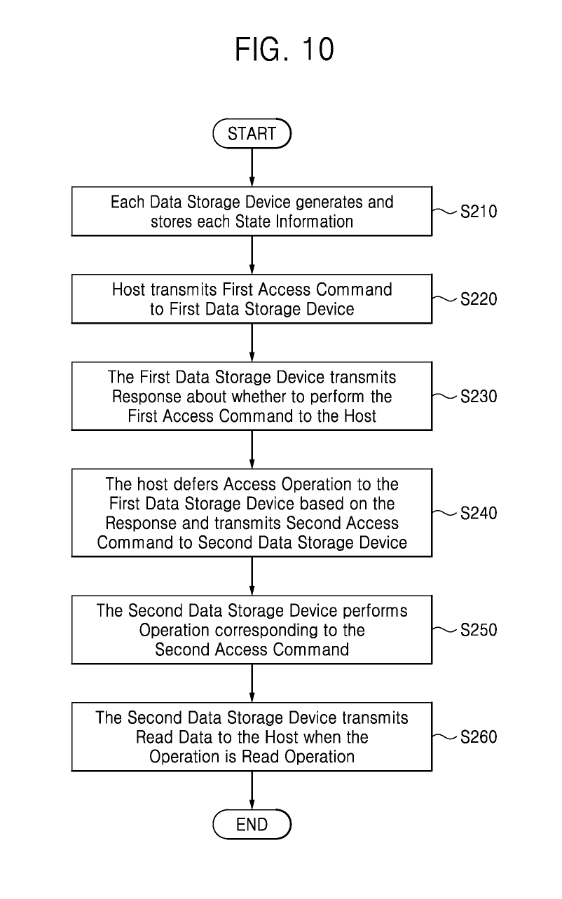

Reference is now made to FIG. 9 which is a schematic block diagram of a data processing system according to still another exemplary embodiment of the present inventive concepts, and to FIG. 10 which is a flowchart for reference in describing an example operation of the data processing system illustrated in FIG. 9.

A data processing system 400 of this example includes a host 200 and a plurality of data storage devices 300-1 to 300-N, where N is a natural number. The data processing system 400 may, for example, be embodied in a database management system (DBMS).

The plurality of data storage devices 300-1 to 300-N may compose a Redundant Array of Independent (or Inexpensive) Disks Inexpensive Disks (RAID). In this case, data may be divided and/or replicated among the plurality of data storage devices 300-1 to 300-N to improve redundancy and performance. Also, an operating system of the host 200 may assess the RAID as a single storage device.

A structure and an operation of each data storage device 300-1 to 300-N may be the same as or substantially the same as the structure and operation of the data storage device 300A of FIG. 2 or the data storage device 300B of FIG. 6 described previously. In operation, each data storage device 300-1 to 300-N generates state information regarding a plurality of memory chips included therein, and stores the generated state information in a corresponding memory (S210 of FIG. 10).

The host 200 transmits a first access command CMD1 which is directed to one of the plurality of data storage devices 300-1 to 300-N (here, referred to as a first data storage device 300-2) among the plurality of data storage devices 300-1 to 300-N (S220 of FIG. 10). The first data storage device 300-2 analyzes state information regarding first memory chips embedded in the first data storage device 300-2 in response to the first access command CMD1, and transmits a response RES related to the first access command CMD1 to the host 200 according to a result of the analyzing (S230 of FIG. 10).

The host 200 suspends (or defers) an access operation to the first data storage device 300-2 based on the received response RES, and transmits a second access command CMD2 to another one of the plurality of data storage devices 300-1 to 300-N (here, referred to as a second data storage device 300-N) (S240 of FIG. 10).

The second data storage device 300-N performs an operation corresponding to the second access command CMD2 on second memory chips embedded in the second data storage device 300-N (S250 of FIG. 10).

When the operation corresponding to the second access operation CMD2 is a read operation, the second data storage device 300-N transmits read data DATA read by at least one of the second memory chips to the host 200 according to the operation (S260 of FIG. 10).

As described above, when a background operation is performed or is to be performed in the first data storage device 300-2, the first data storage device 300-2 may not perform a read operation or a write operation corresponding to the first access command CMD1 within a normal time period in response to the first access command CMD1 output from the host 200.

Here, the normal time period is a time period that elapses during execution of a normal read operation or a normal write operation which is determined according to design specifications of each of the plurality of data storage devices 300-1 to 300-N. In this case, the first data storage device 300-2 may output a fast response RES, which represents a read operation or a write operation corresponding to the first access command CMD1 may not be performed within the normal time, to the host 200. Accordingly, the host 200 may output a second access command CMD2 related to the first access command CMD1 to the second data storage device 300-N based on the fast response RES.

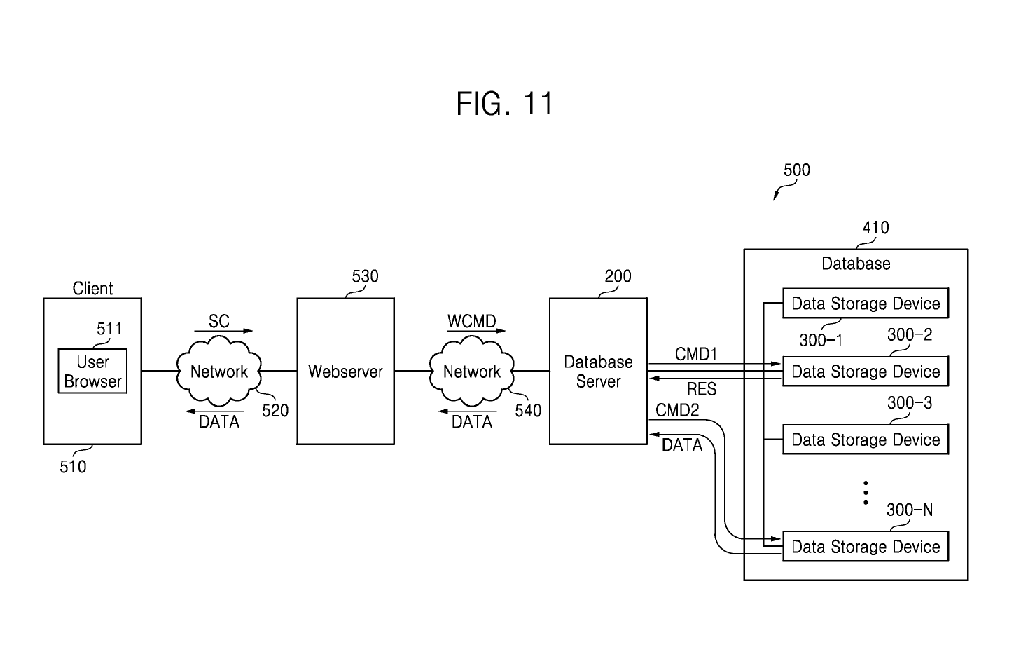

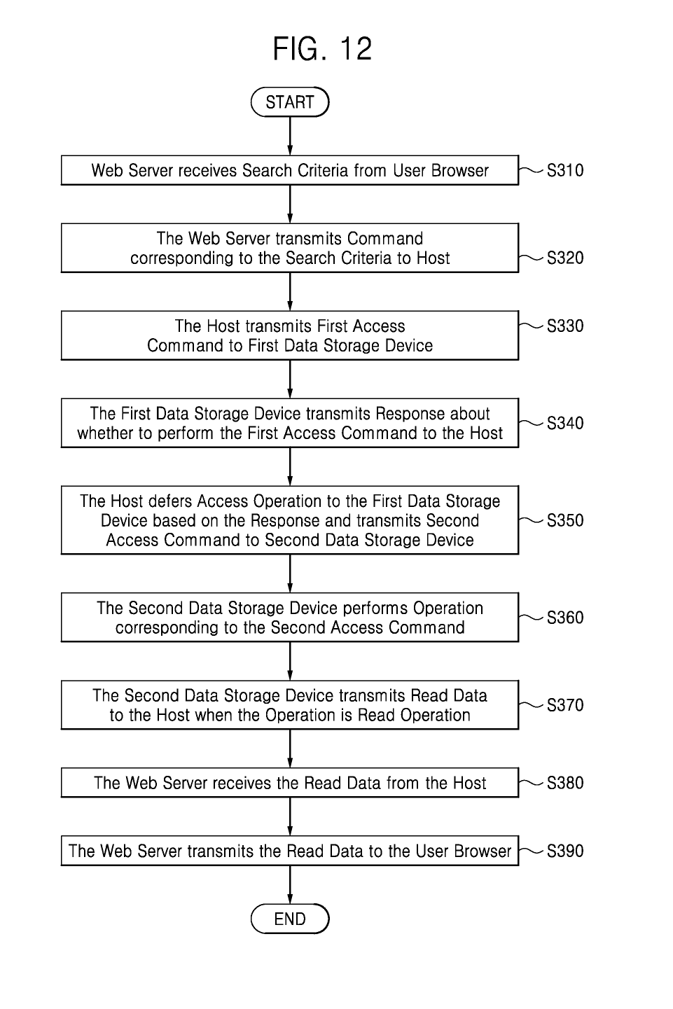

FIG. 11 is a schematic block diagram of a data processing system according to still another exemplary embodiment of the present inventive concepts, and FIG. 12 is a flowchart for describing an operational example of the data processing system illustrated in FIG. 11.

A data processing system 500 includes a client computer 510 (referred to simply as a client), a first network 520, a web server 530, a second network 540, a database server 200, and a database 410. The data processing system 500 may be embodied in a database management system (DBMS). The data processing system 500 may be a web portal.

The client 510 includes a user browser 511, and the user browser 511 may be a web browser. When the user browser 511 transmits a search criteria SC, e.g., a search keyword, input from a user through an input device, e.g., keyboard, mouse, or touch screen, to the web server 530 through the first network 520 (S310), the web server 530 receives the search criteria SC from the user browser 511 (S310). The first network 520 may be a wired internet or a wireless internet or a combination thereof.

The web server 530 transmits a command WCMD corresponding to the search criteria SC to the database server 200 through the second network 540 (S320). The database server 200 may perform the same function as the host 200. The second network 540 may be a wired internet, a wireless internet, and/or an intranet.

The database 410 is defined as a physical device including the plurality of data storage devices 300-1 to 300-N. Each data storage device 300-1 to 300-N generates state information on a plurality of memory chips included therein, and stores the generated state information in a corresponding memory. The database server 200 transmits the first access command CMD1 to the first data storage device 300-2 (S330).

The first data storage device 300-2 analyzes state information on the first memory chips embedded in the first data storage device 300-2 in response to the first access command CMD1, and transmits the response RES about whether to perform the first access command CMD1 to the database server 200 according to a result of the analyzing (S340). The first access command CMD1 may be a read command or a write command corresponding to the search criteria SC.

The web server 530 or the database server 200 may include a keyword search engine. The host 200 defers an access operation to the first data storage device 300-2 based on the received response RES, and transmits the second access command CMD2 to the second data storage device 300-N (S350).

The second data storage device 300-N performs an operation corresponding to the second access operation CMD2 on the second memory chips embedded in the second data storage device 300-N (S360). When the operation corresponding to the second access command CMD2 is a read operation, the second data storage device 300-N transmits read data read by at least one of the second memory chips based on the operation to the database server 200 (S370).

The web server 530 receives the read data DATA from the database server 200 through the second network 540 (S380). The web server 530 transmits the read data DATA to the user browser 511 of the client 510 through the first network 520 (S390). Accordingly, the user browser 511 may display the read data DATA corresponding to the search criteria SC through a display.

A data storage device according to an exemplary embodiment of the present inventive concepts and an operation method thereof may analyzes state information on a plurality of memory chips embedded in the data storage device based on an access command output from a host, and when data processing latency associated with execution of the access command is determined to be excessive according to a result of the analyzing, outputs a fast response indicative of the determination to the host. Accordingly, the host may request a data processing associated the access command to other data storage devices, and thereby the host may promptly process data.

While the present inventive concepts have been particularly shown and described with reference to example embodiments thereof, it will be understood by those of ordinary skill in the art that various changes in forms and details may be made therein without departing from the spirit and scope of the present inventive concepts as defined by the following claims.

1. A method of operating a data storage device including a plurality of memory chips, the method comprising:
generating state information regarding the plurality of memory chips, and storing the generated state information in a memory;
receiving an access command from a host; and
analyzing the state information in response to the access command, and transmitting a response to the host indicative of whether the access command is performed based on the analyzed state information.

2. The method of claim 1, wherein the state information includes information regarding a background operation of each of the plurality of chips.

3. The method of claim 2, wherein the background operation includes at least one of a garbage collection operation, a wear-level operation, and a bad-block management operation.

4. The method of claim 1, wherein the state information includes information regarding at least one of a program operation, a read operation, and an erase operation to be performed in each of the plurality of memory chips.

5. The method of claim 1, wherein the state information includes information regarding a state of a bus connected to the plurality of memory chips.

6. The method of claim 1, wherein the state information includes information regarding an operation being currently performed in the plurality of memory chips.

7. The method of claim 1, wherein the access command includes one of a read command and a write command.

8. The method of claim 1, wherein the response is indicative of whether the access command is being currently performed.

9. The method of claim 1, wherein the response is indicative of a latency at which the access command will be performed.

10. The method of claim 1, wherein the response is a timeout response or an abort response.

11. A method of operating a data storage device including a plurality of memory chips, the method comprising:
generating state information regarding the plurality of memory chips, and storing the generated state information in a memory;
receiving an access command from a host; and
analyzing the state information in response to the access command to determine whether an addressed one of the plurality of memory chips is currently available, and transmitting a response to the host based on the analyzed state information,
wherein, when the addressed one of the plurality of memory chips is determined to be currently available, the response is indicative of the access command being performed, and
wherein, when the addressed one of the plurality of memory chips is determined to be currently not available, the response is indicative of at least one of the access command not being performed and a latency at which the access command will be performed.

12. A method of operating a data processing system which includes a first data storage device having first memory chips, a second data storage device having second memory chips, and a host, the method comprising:
transmitting, by the host, a first access command to the first data storage device;
analyzing, by the first data storage device, state information regarding the first memory chips in response to the first access command, and transmitting a response indicative of whether to execute the first access command based on a result of the analyzing;
deferring, by the host, an access operation to the first data storage device based on the response and transmitting a second access command to the second data storage device; and
performing, by the second data storage device, an operation corresponding to the second access command to the second memory chips.

13. The method of claim 12, wherein the first data storage device generates the state information before receiving the first access command,
wherein the state information includes at least one of information regarding a background operation, an operation count to be performed in each of the plurality of memory chips, a state of a bus connected to the plurality of memory chips, and an operation being currently performed in the plurality of memory chips.

14. The method of claim 12, wherein the response is indicative of whether the access command is being currently performed or a latency at which the access command will be performed.

15. The method of claim 12, wherein the first data storage device and the second data storage device are included in a Redundant Array of Independent Disks or Redundant Array of Inexpensive Disks (RAID).

16. The method of claim 12, wherein the first data storage device and the second data storage device are solid state drives (SSDs), and the first memory chips and the second memory chips are flash memory chips.

17. The method of claim 12, wherein the first data storage device and the second data storage device are included in a database, the host is a database server, and the data processing system is a database management system (DBMS).

18. The method of claim 12, further comprising transmitting to the host, by the second data storage device, read data read according to the operation corresponding to the second access command.

19. The method of claim 12, further comprising:
receiving, by a web server connected to the host, a search criteria from a user browser;
transmitting, by the web server, a command corresponding to the search criteria to the host; and
generating, by the host, the first access command corresponding to the command.

20. The method of claim 19, further comprising:
transmitting, by the second data storage device, read data read according to the operation corresponding to the second access command to the host;
transmitting, by the host, the read data to the web server; and
transmitting, by the web server, the read data transmitting from the web server to the user browser.

21-25. (canceled)
